(19) United States
(12) Patent Application Publication
(10) Pub. No.: US 2008/0176643 A1
(43) Pub. Date: Jul. 24, 2008

(54) Systems And Methods For Flexible Wagering

(75) Inventors: Gareth Phillips, Manchester (GB); Scott Olive, Narrabeen (AU); Lattamore D. Osburn, Las Vegas, NV (US); John Denlay, Las Vegas, NV (US); Christine J. Denlay, Las Vegas, NV (US); Michael Dugan, Colorado Springs, CO (US); Gary Frerking, Henderson, NV (US); Kent Reisdorph, Henderson, NV (US)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY, LTD., Lane Cove (AU)

(21) Appl. No.: 11/937,964

(22) Filed: Nov. 9, 2007

Related U.S. Application Data
(60) Provisional application No. 60/857,812, filed on Nov. 10, 2006.

(51) Int. Cl. A63F 9/24; G06F 17/30

(52) U.S. Cl. 463/25; 707/201

(57) ABSTRACT

Certain embodiments of the present invention provide a system for flexible wagering including a game at which a wager may be placed on an event in the game and an odds monitoring processor adapted to determine a payout of a flexible wager by a player. The flexible wager is based on a plurality of events. At least one of the plurality of events is the event in the game. The payout is based on a combination of odds of each of said events occurring.

### RELATED APPLICATIONS

This application is related to, and claims the benefit of, Provisional Application No. 60/857,812, filed on Nov. 10, 2006, and entitled “Method and System for Increased Flexibility in Setting and Maintaining Odds in a Plurality of Wagering Games.” The foregoing application is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to wagering for a variety of games. More specifically, the present invention relates to systems and methods for flexible wagering.

Traditional operators of wagering games (referred to herein as “casinos”) tend to be very limited in the odds used in the games. That is, house odds (odds set or selected by the casino or odds determined by the rules of play of the game and pay outs for certain propositions) for games tend to be fixed or may only vary within very narrow ranges. For example, a casino may buy a slot machine which mathematically has odds of any winning outcome occurring and an award for each winning outcome. The odds and pay outs are used to determine the overall mathematically expected performance for the game, e.g. to hold 20% of all wagers. In certain table games, such as Blackjack, may affect the odds such as restricting when a player can “split” their hand or “double down”.

In addition, traditional wagering or gambling games are limited to wagers on a single event or occurrence. In traditional table games, such as Blackjack or roulette, players are limited to placing bets on single events or occurrences, for example. For example, in Blackjack, players typically wager on a single hand. As another example, in roulette, players wager on a single spin of the wheel. These types of games typically do not permit wagering on multiple events or occurrences.

Providing a casino with greater flexibility in setting and managing the odds of various games, including table games, can increase revenue for the house and the number of players wagering at the casino. For example, a casino with the ability to provide players with opportunities to wager on several occurrences or outcomes can have increased flexibility in setting and managing the odds of various games.

### BRIEF SUMMARY OF THE INVENTION

Certain embodiments of the present invention provide a system for flexible wagering including a game at which a wager may be placed on an event in the game and an odds monitoring processor adapted to determine a payout of a flexible wager by a player. The flexible wager is based on a plurality of events. At least one of the plurality of events is the event in the game. The payout is based on a combination of odds of each of said events occurring.

Certain embodiments of the present invention provide a method for flexible wagering including receiving a flexible wager from a player and determining a payout of the flexible wager. The flexible wager is based on a plurality of events. At least one of the plurality of events is an event in a first game. The payout is based on a combination of odds of each of said events occurring.

Certain embodiments of the present invention provide a computer-readable medium including a set of instructions for execution on a computer, the set of instructions including a flexible wager reception routine configure to receive a flexible wager from a player and a payout determination routine configure to determine a payout of the flexible wager. The flexible wager is based on a plurality of events. At least one of the plurality of events is an event in a first game. The payout is based on a combination of odds of each of said events occurring.

### BRIEF DESCRIPTION OF SEVERAL VIEWS OF THE DRAWINGS

FIG. 1 illustrates a system for flexible wagering in accordance with an embodiment of the presently invention.

FIG. 2 illustrates a flow diagram for a method for flexible wagering in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Embodiments of the presently described technology provide casinos with the ability to set and maintain flexible odds on a variety of games by permitting players to make flexible wagers on multiple gaming events.

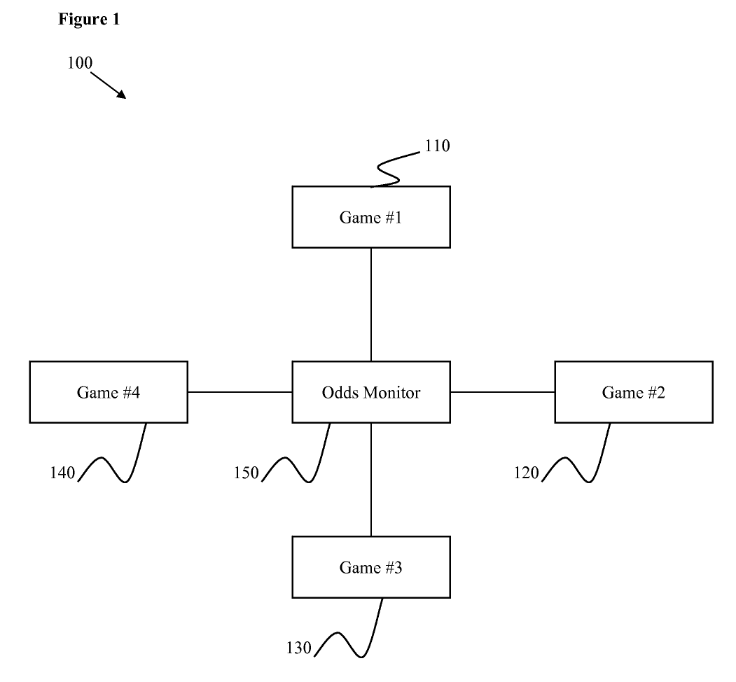

FIG. 1 illustrates a system 100 for flexible wagering in accordance with an embodiment of the presently invention. The system 100 includes four wagering games 110, 120, 130, and 140, and an odds monitor 150. While FIG. 1 illustrates four games, games 110 through 140, a larger or smaller number of games may be used in accordance with various embodiments of the presently described technology. For example, as few as a single game 110 may be used in accordance with various embodiments.

The odds monitor 150 is in communication with the games 110 through 140. The odds monitor 150 may communicate with the games 110 through 140 through a wired or wireless electronic communications connection, or by visually monitoring each of games 110 through 140, for example.

In operation, the system 100 provides players wagering at one or more of the games 110 through 140 with the ability to make a flexible wager on the occurrence of multiple game events.

Each of games 110 through 140 is a wagering game, or a game. That is, each game 110 through 140 is a game at which a player may bet on an event or occurrence such as the outcome. For example, each of games 110 through 140 may be embodied in a Blackjack game, poker game, roulette game, a slot machine game, electronic gaming machine, and/or a craps game. However, other wagering games may be played at each of games 110 through 140. That is, each of games 110 through 140 may be the same or different games. For example, game 110 may be a Blackjack game, game 120 may be a roulette game, game 130 may be a slot machine, and game 140 may be a craps game.

In certain embodiments, a player playing at game 110, rather than being limited to wagering only on single events or outcomes of the game being played at game 110, may make a flexible wager on the occurrence of multiple events at game 110. For example, if game 110 is a roulette game, a player may wager on the occurrence of a red winning number followed by a black winning number followed by another black winning number. In another example, the player may wager on the number of occurrences of a given outcome at game 110 within a specified time limit. In such an example, a player may wager on the number of times a red winning number will occur at a roulette game 110 within the next 20 spins.

In certain embodiments, a player playing at game 110 may make a flexible wager on the occurrence of multiple events at other games, such as games 120 through 140. For example, while a first player is playing at game 110, the first player may make a flexible wager on an occurrence at another game being played at game 120 by a second player, in addition to the outcome of the game 110. In such an example, the first player may wager on a black winning number at game 110 and a red winning number at game 120.

The flexible wager may include independent wagers or dependent wagers. By independent wagers, it is meant that each wager at each game 110 through 140 being played by a player wins or loses on its own as if the player were playing each game independently. By dependent wagers, it is meant that all wagers at the various games 110 through 140 being played by a player win or lose together. For example, if a player wagers on outcomes of games at each of game 110, 120, and 130 and wins at games 110 and 120, but loses at game 130, the player's wager may lose.

In an embodiment of the presently described technology, players may make a flexible wager on the occurrence of one or more within a given time period. For example, a player may make a flexible wager on a certain number of winning hands of Blackjack (by players) at two or more of games 110 through 140 within a given time period. In such an example, a player may wager that all players playing Blackjack at games 130 and 140 will win 50 hands of Blackjack within the next 10 minutes. As another example, a player may wager on the number of times a red winning number will occur at a roulette game 110 within the next 20 minutes.

In another embodiment of the presently described technology, a player may make a flexible wager on multiple games being played at a single or multiple games 110, 120, 130, 140. For example, a player at a Blackjack table being played at game 140 may wager on the hands of other players at game 140 or at another game 110, 120 or 130 in addition to his own.

The odds monitor 150 is adapted to determine the odds and/or payouts for flexible wagers placed at one or more of games 110 through 140 or at a combination of a plurality of games 110 through 140. For example, the odds monitor 150 may calculate the payout for the game 110 based on a player's wager and the outcome of a play of the game 110.

The odds monitor 150 may be embodied in a computing device, for example. However, various devices and apparatuses comprising a processor and adapted to carry out one or more functions at the direction of a set of instructions for a computer (such as computer software applications or code) may be used as odds monitor 150 without departing from the scope of embodiments of the presently described technology.

The odds monitor 150 is adapted to monitor the odds and/or wagers placed at each of the games 110 through 140. The odds monitor 150 tracks the odds for wagers placed by each player at one or more the games 110, 120, 130, 140. The odds monitor 150 may also track payouts to players based on winning wagers, for example.

Embodiments of the presently described technology provide, among other things, increased flexibility in setting and maintaining odds by providing casinos with the ability to allow players to place concurrent wagers at a plurality of games. This ability is akin to providing players with a wagering opportunity on a slot machine with several reels. That is, a given game 110 through 140 may be thought of as having characters or objects that players wager on overlaid across some number of spaces. For example, a roulette game could be viewed as a reel with 38 spaces. This may be similar to a slot machine virtual reel strip, for example. When players wager on a combination of occurrences at a plurality of games 110 through 140, the additional games 110 through 140 may be thought of as adding reel strips to a slot machine virtual reel strip that is managed by the odds monitor 150. In continuing with this example, when the odds for one game 110, 120, 130 or 140 are read in combination with all other such table game outcomes by the odds monitor 150, the odds effectively start at 38×38×38 (for each space or possible occurrence at each game 110, 120, 130, 140 being wagered on, assuming each is a roulette game) or such higher range of probabilities as may be determined by a virtual mapping concept, for example. In essence, each wagering game 110, 120, 130, 140 or gaming table becomes a reel in the virtual slot machine managed by the odds monitor 150. By wagering on three to five games 110, 120, 130, 140, a player effectively wagers on a three to five reel slot machine game, for example. Accordingly, the odds for the flexible wagering can be calculated and the player may be given the wagering proposition at odds sufficient to meet (1) regulatory restrictions on maximum odds, (2) a reasonable award sufficient to encourage the player to place the wager and (3) a reasonable return to the casino for “banking” the wager.

By permitting players to place concurrent wagers on a plurality of games 110, 120, 130, 140, the odds monitor 150 may calculate longer odds or higher payouts to winning players. High “jackpot” prizes may then become available for players to wager on. The jackpot wager may be in addition to a game 110 through 140 on which a given player is already wagering, for example. In other words, by combining the ability to wager on the base game 110, 120, 130, 140 that a player is currently wagering on with the ability to concurrently wager on additional games 110, 120, 130, 140, an operator or user of the odds monitor 150 has the ability to offer significant jackpot prizes, and at the same time increase the operator's net return on game turnover.

In an embodiment of the presently described technology, other payouts are possible using the odds monitor 150. For example, a player may win a wager or part of a wager if that player concurrently wagers on multiple games 110, 120, 130, 140 and wins one or more, but not all, of the wagers. In addition, a player that places concurrent wagers on multiple games 110, 120, 130, 140 may win part or all of his or her wager if none of that player's wagers win, for example.

In an embodiment of the presently described technology, a player may be provided with the ability to wager on subsequent games. That is, embodiments of the presently described technology are not limited to wagers placed on concurrent or simultaneously played games 110, 120, 130, 140. Instead, a player may wager on a first game played at game 110, followed by a second game played next at game 120, followed by a third game played next at game 130, and finally followed by a fourth game played at game 140.

In addition, a player may also increase his wagers at one or more games 110, 120, 130, 140 as each game is played. For example, after a player wins a wager on a first round of a game 110, 120, 130, 140, he/she has the ability to ante up, or to raise his/her stake or wager at the next wager (whether this next wager is at the same or different game 110, 120, 130, 140). Alternatively, the player may be provided with the opportunity to collect his/her winnings after an opening winning wager at a first game 110, 120, 130, 140 and remove a wager originally placed on multiple games 110, 120, 130, 140. Alternatively, a player may be provided with the opportunity to take “insurance” after an opening winning wager at a first game 110, 120, 130, 140 against a wager originally placed on multiple games 110, 120, 130, 140.

The components, elements, and/or functionality of the system 100 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device.

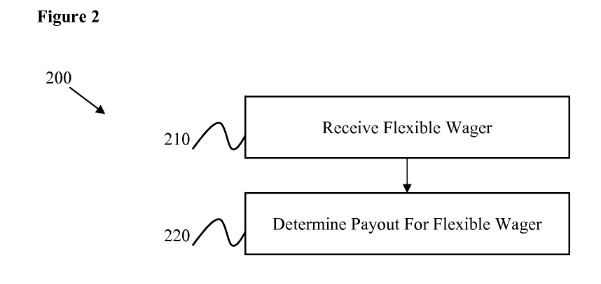

FIG. 2 illustrates a flow diagram for a method 200 for flexible wagering in accordance with an embodiment of the present invention. The method 200 includes the following steps, which will be described below in more detail. At step 210, a flexible wager is received. At step 220, a payout is determined for the flexible wager. The method 200 is described with reference to elements of systems described above, but it should be understood that other implementations are possible.

At step 210, a flexible wager is received. The flexible wager may be received at an odds monitor similar to the odds monitor 150, described above, for example. The flexible wager may be made by a player, for example. The player may be playing a wager game similar to games 110 through 140, described above, for example.

In certain embodiments, a player playing at game 110 may make a flexible wager on the occurrence of multiple events at game 110. For example, if game 110 is a roulette game, a player may wager on the occurrence of a red winning number followed by a black winning number followed by another black winning number. In another example, the player may wager on the number of occurrences of a given outcome at game 110 within a specified time limit. In such an example, a player may wager on the number of times a red winning number will occur at a roulette game 110 within the next 20 minutes.

In certain embodiments, a player playing at game 110 may make a flexible wager on the occurrence of multiple events at other games, such as games 120 through 140. For example, while a first player is playing at game 110, the first player may make a flexible wager on an occurrence at another game being played at game 120 by a second player, in addition to the outcome of the game 110. In such an example, the first player may wager on a black winning number at game 110 and a red winning number at game 120.

The flexible wager may include independent wagers or dependent wagers. By independent wagers, it is meant that each wager at each game 110 through 140 being played by a player wins or loses on its own as if the player were playing each game independently. By dependent wagers, it is meant that all wagers at the various games 110 through 140 being played by a player win or lose together. For example, if a player wagers on outcomes of games at each of game 110, 120, and 130 and wins at games 110 and 120, but loses at game 130, the player's wager may lose.

In an embodiment of the presently described technology, players may make a flexible wager on the occurrence of one or more within a given time period. For example, a player may make a flexible wager on a certain number of winning hands of Blackjack (by players) at two or more of games 110 through 140 within a given time period. In such an example, a player may wager that all players playing Blackjack at games 130 and 140 will win 50 hands of Blackjack within the next 10 minutes. As another example, a player may wager on the number of times a red winning number will occur at a roulette game 110 within the next 20 minutes.

In another embodiment of the presently described technology, a player may make a flexible wager on multiple games being played at a single or multiple games 110, 120, 130, 140. For example, a player at a Blackjack table being played at game 140 may wager on the hands of other players at game 140 or at another game 110, 120 or 130 in addition to his own.

At step 220, a payout is determined for the flexible wager. The payout may be determined by an odds monitor similar to the odds monitor 150, described above, for example. The flexible wager may be the flexible wager received at step 210, described above, for example.

For example, the odds monitor 150 may calculate the payout for the game 110 based on a player's wager and the outcome of a play of the game 110.

Embodiments of the presently described technology provide, among other things, increased flexibility in setting and maintaining odds by providing casinos with the ability to allow players to place concurrent wagers at a plurality of games. This ability is akin to providing players with a wagering opportunity on a slot machine with several reels, as discussed above.

By permitting players to place concurrent wagers on a plurality of games 110, 120, 130, 140, the odds monitor 150 may calculate longer odds or higher payouts to winning players. High “jackpot” prizes may then become available for players to wager on. The jackpot wager may be in addition to a game 110 through 140 on which a given player is already wagering, for example. In other words, by combining the ability to wager on the base game 110, 120, 130, 140 that a player is currently wagering on with the ability to concurrently wager on additional games 110, 120, 130, 140, an operator or user of the odds monitor 150 has the ability to offer significant jackpot prizes, and at the same time increase the operator's net return on game turnover.

In an embodiment of the presently described technology, other payouts are possible. For example, a player may win a wager or part of a wager if that player concurrently wagers on multiple games 110, 120, 130, 140 and wins one or more, but not all, of the wagers. In addition, a player that places concurrent wagers on multiple games 110, 120, 130, 140 may win part or all of his or her wager if none of that player's wagers win, for example.

In an embodiment of the presently described technology, a player may be provided with the ability to wager on subsequent games. That is, embodiments of the presently described technology are not limited to wagers placed on concurrent or simultaneously played games 110, 120, 130, 140. Instead, a player may wager on a first game played at game 110, followed by a second game played next at game 120, followed by a third game played next at game 130, and finally followed by a fourth game played at game 140.

In addition, a player may also increase his wagers at one or more games 110, 120, 130, 140 as each game is played. For example, after a player wins a wager on a first round of a game 110, 120, 130, 140, he/she has the ability to ante up, or to raise his/her stake or wager at the next wager (whether this next wager is at the same or different game 110, 120, 130, 140). Alternatively, the player may be provided with the opportunity to collect his/her winnings after an opening winning wager at a first game 110, 120, 130, 140 and remove a wager originally placed on multiple games 110, 120, 130, 140. Alternatively, a player may be provided with the opportunity to take “insurance” after an opening winning wager at a first game 110, 120, 130, 140 against a wager originally placed on multiple games 110, 120, 130, 140.

One or more of the steps of the method 200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide systems and methods for flexible wagering. Certain embodiments provide a technical effect of flexible wagering.

Examples of systems and methods providing additional wagering opportunities with respect to electronic gaming machines can be found in co-pending and co-owned U.S. patent application Ser. No. 11/552,404, filed on Oct. 24, 2006, and entitled “System and Method for Slot System Wagering.”

While particular elements, embodiments and applications of the present invention have been shown and described, it is understood that the invention is not limited thereto since modifications may be made by those skilled in the art, particularly in light of the foregoing teaching. It is therefore contemplated by the appended claims to cover such modifications and incorporate those features that come within the spirit and scope of the invention.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A system for flexible wagering, the system including:
a game at which a wager may be placed on an event in the game; and
an odds monitoring processor adapted to determine a payout of a flexible wager by a player, wherein the flexible wager is based on a plurality of events, wherein at least one of the plurality of events is the event in the game, and wherein the payout is based on a combination of odds of each of said events occurring.

2. The system of claim 1, wherein the game is a blackjack game, a poker game, a roulette game, a slot machine game, an electronic gaming machine, and/or a craps game.

3. The system of claim 1, wherein at least one of the plurality of events occurs in a second game.

4. The system of claim 3, wherein the second game is different from the first game.

5. The system of claim 3, wherein the second game is played by a second player.

6. The system of claim 1, wherein the flexible wager is time limited.

7. The system of claim 1, wherein at least one event in the plurality of events is the outcome of the game.

8. The system of claim 1, wherein the plurality of events includes multiple outcomes of the game.

9. The system of claim 1, wherein the flexible wager allows the player to alter a stake after an opening wager.

10. The system of claim 1, wherein the flexible wager allows the player to take insurance after an opening wager.

11. The system of claim 1, wherein the flexible wager includes a dependent wager.

12. The system of claim 1, wherein the flexible wager includes an independent wager.

13. A method for flexible wagering, the method including:
receiving a flexible wager from a player, wherein the flexible wager is based on a plurality of events, wherein at least one of the plurality of events is an event in a first game; and
determining a payout of the flexible wager, wherein the payout is based on a combination of odds of each of said events occurring.

14. The system of claim 13, wherein at least one of the plurality of events occurs in a second game.

15. The system of claim 14, wherein the second game is different from the first game.

16. The system of claim 14, wherein the second game is played by a second player.

17. The system of claim 13, wherein the flexible wager is time limited.

18. The system of claim 13, wherein the flexible wager allows the player to alter a stake after an opening wager.

19. The system of claim 13, wherein the flexible wager allows the player to take insurance after an opening wager.

20. A computer-readable medium including a set of instructions for execution on a computer, the set of instructions including:
a flexible wager reception routine configure to receive a flexible wager from a player, wherein the flexible wager is based on a plurality of events, wherein at least one of the plurality of events is an event in a first game; and
a payout determination routine configure to determine a payout of the flexible wager, wherein the payout is based on a combination of odds of each of said events occurring.
